(19) United States
(12) Patent Application Publication
(10) Pub. No.: US 2007/0248359 A1
(43) Pub. Date: Oct. 25, 2007

(54) Multiport optical transceiver

(76) Inventors: Jean-Luc Pamart, Plemeur-Bodou (FR); Francois-Xavier Ollivier, Servel Lannion (FR); Jerome Robillart, Trebeurden (FR)

Correspondence Address: ST. ONGE STEWARD JOHNSTON & REENS, LLC, 986 BEDFORD STREET, STAMFORD, CT, 06905-5619, US

(21) Appl. No.: 11/410,467

(22) Filed: Apr. 25, 2006

(51) Int. Cl. H04B 10/00

(52) U.S. Cl. 398/135

(57) ABSTRACT

An optical transceiver device having multiple communication related functions is integrated into a single module, as well as capabilities for integrating a DSP and optical side send/receive processing. The optical transceiver device provides client-access and line-access operations on the optical layers for traffic control and security, and enables parallel implementation.

### FIELD OF THE INVENTION

This invention relates to methods and systems for providing optical communications. In particular, the present invention relates to a multiport optical transceiver having multiple communication related functions, as well as functionalities for interfacing a DSP and optical side send/receive processing into a single multi-interface module.

### BACKGROUND OF THE INVENTION

Optical communication networks facilitate the transmission of digital data using optical signals which are formatted to conform to several different synchronous and asynchronous communication standards. A very well known synchronous optical communications standard is Synchronous Optical Network (SONET). SONET systems require a synchronous transport signal which has associated with it section overhead (SOHO) bytes, frames, transport overhead and payload/data bytes.

SONET systems also allow branching of various DS-1 (i.e., T1 data streams) of 1.54 Mb/s lines, Digital Multiplex Hierarchy (DMH), add/drop multiplexers (ADMs), etc. into the system to interface the transport layer. ADMs may have cross-connect matrices (i.e., switch fabrics) for directing synchronous transferred signals from one interface to another interface within the system or to other systems in the network.

A very common asynchronous protocol, called Asynchronous Transfer Mode (ATM), provides a cell-based transport and switching technology for high-capacity transmission of voice, data and video, in 53-byte cells. By using ADMs with appropriately formatted DS-1 channels, it is well known that ATM cells may be transmitted over SONET. The plethora of details regarding these standards and other communication standards and features are well known in the art and, therefore, are not discussed herein.

Optical communication networks are also understood to require an assortment of dedicated equipment such as optical transceivers, data processors, routers, switches, multiplexers, traffic management servers, control units, network interfaces, etc., all of which in one form or another support a designated communication standard(s) for maintaining communication fidelity and client services.

One critical hardware component for an optical communication system is the optical transceiver. It is well known that the primary function of conventional optical transceivers is to convert optical signals into electrical signals and convert electrical signals into optical signals. The converted signals, if optical, are usually transmitted over the optical network. If electrical, the converted signals are usually digitally processed by a processor or conveyed to other devices, for example, a signal conditioning system or switch. Accordingly, optical transceivers are usually provided with adjunct capabilities, such as, for example, digital signal processing (DSP) or switch fabric interfaces to adapt data received from the optical network for signal conditioning or routing on the client side.

DSPs are typically integrated into optical transceivers to pre or post-condition the signals to adjust the received or transmitted signals to account for propagation distortion, pre-emphasis, chromatic distortion, error correction, birefringent effects, connection or traffic related interferences, etc. DSPs also permit monitoring and control of connection issues or traffic issues for more fault resistant network management.

Concomitant with optical systems utilizing a time-division multiplexing (TDM) paradigm is the implementation of modified optical transceivers to synchronize optical signals of different input data streams with a common clock. In this regard, it is well known that systems are capable of synchronizing the clocks of different input streams with a common clock or with one of the clocks recovered from the input streams.

On the line side of conventional optical transceivers is usually implemented conventional Serdes-Framer Interfaces (SFI4) which electrically restore the signals. However, these and conventional signal conditioning capabilities in optical transceivers tend to operate on the aggregate send or aggregate receive signal rather than on individual optical side access send or receive signals. Moreover, conventional optical transceivers are not provided with interfaces for processors which would render them more intelligent and more independent.

As a result, all of the above paradigms for optical communication systems are, in one form or another, accomplished by connecting physically separate systems or subassemblies into a turnkey or hybridized optical transceiver system. Due to the independent operations of these adjunct systems or subassemblies within the optical transceiver, there is the requirement that these adjunct systems or subassemblies must have compatible interfaces designed for the particular optical transceiver being modified. Further, this adjunct systems or subassemblies must be staged with control/operation priorities to perform proper sequencing of the respective operations within the transceiver system. This process of developing such a hybridized optical transceiver system has imposed an increased cost for optical communication providers when upgrading transceiver systems and designing transceiver system configurations for desired operational functionalities.

Therefore, there has been a longstanding need in the optical transceiver community for a single module, transceiver system with easily interfacable, DSP processing capabilities adaptable to an optical line layer, and client-side optical input/output signal manipulation capabilities.

### SUMMARY OF THE INVENTION

According to a first aspect, the invention relates to a multi-port transceiver system interfacable with an optical transceiver, comprising a signal processor coupled to an optical transceiver, a processor interface coupled to the signal processor, an external interface coupled to the signal processor interface, and a client-side optical transceiver coupled to the signal processor, wherein the processor interface enables communication between the signal processor and an external device coupled to the external interface, and the client-side optical transceiver interface enables transceiving of signals between the signal processor and a client-side optical transceiver coupled to the client-side optical transceiver interface.

According to another aspect, the invention relates to a multi-port transceiver system interfacable with optical transceivers, comprising signal processing means for processing optical transceiving signals, processor interfacing means for interfacing with the signal processing means, external interfacing means for interfacing the processor interfacing means with an external device, and client-side optical transceiver for interfacing the signal processing means with a client-side optical transceiver.

According to another aspect, the invention relates to a method of transceiving optical signals in a multi-port transceiver system having an internal processor and an internal processor interface coupled to an external interface, the method comprising the steps of processing by the internal signal processor, signal received by or for transmission by optical transceivers, providing additional processing to the internal signal processor by coupling an external processor to the external interface and processing by the internal signal processor, a signal communicated by a client-side optical transceiver interface.

Other features and advantages of the invention are described below and are apparent from the accompanying drawings and from the following detailed description.

FIG. 1 is a block diagram of an exemplary multiport optical transceiver system according to this invention.

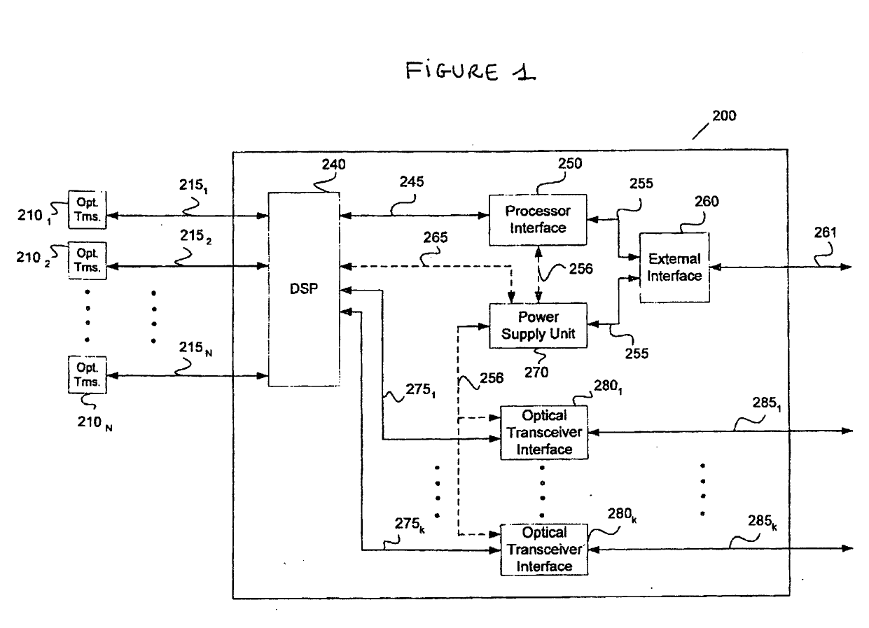

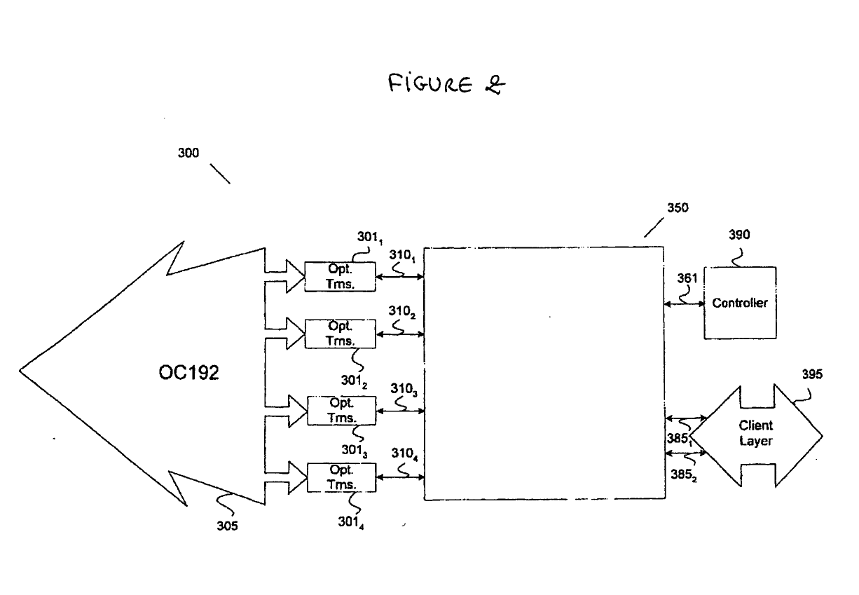

FIG. 2 is a block diagram of the exemplary multiport optical transceiver system of FIG. 1 in multi-gigabit configuration.

### DETAILED DESCRIPTION

Typical optical transceiver systems utilizing SONET, SDH, ATM, etc. networks are developed as turnkey systems wherein most or all of the desired functionalities are provided by connecting separate independent systems to form the desired optical transceiver system. Therefore, conventional optical transceiver systems do not provide a single module capable of performing the desired functionalities, having client side optical inputs/outputs, an optional integrated DSP, or interfacing/deinterfacing capabilities, etc. Accordingly, this invention provides methods and systems for addressing these and other shortcomings in the prior art.

FIG. 1 is a block diagram of an exemplary optical transceiver system 200 according to an embodiment of this invention. The exemplary optical transceiver system 200 includes a digital signal processor (DSP) 240, a processor interface 250, an external interface 260, a power supply 270, and optical transceiver interfaces 280₁-280_{K}.

The DSP 240 is coupled to external optical transceivers 210₁-210_{N} on the line side of the optical transceiver system 200 via bi-directional lines 215₁-215_{N}. The DSP 240 is also coupled to the processor interface 250 via a bi-directional line 245 and also coupled to the optical transceiver interfaces 280₁-280_{K} via bi-directional lines 275₁-275_{K}.

The power supply 270 may be coupled to the DSP 240, optical transceiver interfaces 280₁-280_{K}, and the processor interface 250 via (dashed) lines 265. The power supply 270 may be coupled to the external interface 260 via a bi-directional line 275. The external interface 260 may be coupled to the processor interface 250 and the power supply 270 via bi-directional lines 255.

In operation, multiple signals from the optical transceivers 210₁-210_{N} ingress or egress the line side of the optical transceiver system 200 via lines 215₁-215_{N}. The signals on the lines 215₁-215_{N} may be transmitted and/or received by the optical transceiver system 200 and may be formatted according to SONET, ATM, etc. or according to any known or future developed information transport protocol.

In the optical transceiver system 200, the signals on lines 215₁-215_{N} are processed by the DSP 240, as desired. The DSP 240 performs processing operations on one or more of the forwarded/received signals including, for example, error correction, pre-emphasis, dispersion compensation, optical adaptation, overhead processing, interlacing, de-interlacing, control operations, etc.

The DSP 240 may facilitate various synchronization modes for a TDM configuration, with respect to the signal(s) on lines 215₁-215_{N} or 275₁-275_{K}. For example, the DSP 240 may synchronize the signal(s) on lines 215₁-215_{N} with a local clock (not shown), or a dock recovered from one of the signal(s) on lines 215₁-215_{N}, or an external clock (not shown) via, for example, the external interface 260. Once a clock has been selected, the data streams or signals on lines 215₁-215_{N} can be synchronized to the selected clock. The above operation may similarly be performed for signals on lines 275₁-275_{K}.

It should be understood by one of ordinary skill that the DSP 240 may be represented by any combination of one or more programmable or special purpose computing devices such as, for example, microprocessors, micro-controllers, transputers, ASIC, PLD, PLA, FPGA's, sequential or parallel computing devices, etc. that is capable of manipulating data. Additionally, the plethora of digital signal processing systems or functions that digital signal processing can perform are well known in the art and, therefore, are not elucidated in any further detail. Thus, it should be apparent to one of ordinary skill that digital signal processing methods or systems for incorporation into the invention are not limited to the examples or functions provided above.

Signals processed by the DSP 240 are bi-directionally transmitted, as desired, to the processor interface 250 via the line 245 for processing by an optional secondary processor (not shown). The optional secondary processor (not shown) may be incorporated into the processor interface 250. That is, the processor interface 250 may simply be an interface for mating or connecting the optional secondary processor. Additionally, signals from the processor interface 250 may be bi-directionally transmitted to the DSP 240 for additional or independent processing, as desired. Therefore, the processor interface 250 may accommodate interlacing operations and/or de-interlacing operations on the signals, as desired, as well as any function capable of being performed by the DSP 240. Thus, load sharing or task sharing between the DSP 240 and the processor interface 250 may be performed.

The processor interface 250 may also operate as a signal conditioning or buffering device, permitting the signal on line 245 to be processed by an external system (not shown), connected to the external Interface 260.

The power supply unit 270 supplies power, as needed, to any device connected to the external interface 260. Therefore, the power supply unit 270 may optionally provide power in any combination of a steady state, variable, or pulse form to the DSP 240, processor interface 250, etc., or to any device (not shown) connected to the external interface 260. The power supply unit 270 may incorporate signal or power filtering capabilities, for example, for reducing external or internal power noise. Additionally, control of the power supply unit 270 may be accomplished by any of the devices connected to it as well as by control signals from an external controller (not shown) connected to the external interface 260.

The external interface 260 may take the form of an electrical connector and facilitate the transfer of data or control signals via line 275 to and from the processor interface 250 to any device (not shown) connected to the external interface 260. The external interface 260 also may accommodate the delivery of external feeds, add/drop links, clock synchronization signals, temperature compensation signals, data buses, and optical transceivers, etc., for example.

Of course, it is appreciated by one of ordinary skill that the advantages provided by incorporating an external interface 260, as in the present optical transceiver system 200, is not limited to the examples provided above, as innumerable devices or systems may be mated to an appropriately configured external interface 260. Any such device or system may include any of the components or system(s) already described above or any other device or system suitable for operation with the optical transceiver system 200. For example, an external controller (not shown) may be connected to the external interface 260 and provide controlling functions for any of the devices of the optical transceiver system 200 connected directly or indirectly to the external interface 260.

In addition to the signals conveyed via line 245, between the DSP 240 to the processor interface 250, additional signals to and from the DSP 240 may be conveyed over lines 275₁-275_{K} to optical transceiver interfaces 280₁-280_{K}. The optical transceiver interfaces 280₁-280_{K} may contain optical transceivers (not shown) or may be connected to external optical transceivers (not shown) to provide independent processing, operation and controlling of access, etc. to separate client-side optical line layer(s), 285₁-285_{K}, for example. The DSP 240 may interlace or de-interlace the processed signals from lines 215₁-215_{N} onto lines 275₁-275_{K}, or vice versa. Optionally, the optical transceiver interfaces 285₁-285_{K}, individually or corporately, may interlace or de-interlace the signals on line(s) 275₁-275_{K} onto lines 285₁-285_{K}.

Due to the modularity inherently available in using an optical transceiver interface, versus an optical transceiver, the optical transceiver interfaces 280₁-280_{K} may separately accommodate Wavelength-Division-Multiplexing (WDM) capabilities by incorporating, such as, for example, WDM transceivers for WDM multiplexing in a client-side downstream or upstream path.

Accordingly, the provision(s) for an external interface 260, with a processor interface 250 and the transceiver interfaces 280₁-280_{K}, multiple modes for interfacing various systems as well as client-side processing can be accommodated in a convenient single module system.

FIG. 2 is a block diagram of the exemplary embodiment shown in FIG. 1 operating with a multi-gigabit physical layer capacity. Particularly, the embodiment of FIG. 1 is adapted to support an OC192 layer capable of sustaining a 9.6 gigabits per second (Gbps) data rate.

System 300 contains an exemplary optical transceiver system 350, an external controller 390, a client layer 395, and a physical line OC192 layer 305 connected to a plurality of OC48 (2.4 gigabit capable) bi-directional optical transceivers 301₁-301₄, shown in this example as having four optical transceivers. It should be appreciated that while FIG. 2 illustrates four optical transceivers 301₁-301₄, this embodiment may employ more or less optical transceivers, as desired.

In operation, optical signals communicated over the OC192 layer 305 are transceived by the OC48 optical transceivers 301₁-301₄ into electrical data signals. The transceived electrical data signals are communicated to the optical transceiver system 350, via bi-directional lines 310₁-310₄. The optical transceiver system 350 operates on the signals to perform any one or more of numerous functions that comport with the capabilities and description provided herein for the optical transceiver system described in FIG. 1.

The processed signals may be re-transmitted over lines 310₁-310₄ and/or communicated over lines 385₁-385₂ to the client layer 395. The optical transceiver system 350 may be controlled by the controller 390, via line 361, to provide external clocking information, traffic flow monitoring, etc. It should be appreciated by one of ordinary skill that the list of operations that can be performed by the controller 390 are considerable. Therefore, one of ordinary skill should recognize that innumerable other examples of externally controlling or communicating with the optical transceiver system 350 are available and, thus, the scope of the invention is not limited to the examples provided above.

It is emphasized that the above-detailed examples are intended only to be exemplary and not limiting. Accordingly, various modifications may be made to the system without departing from the spirit and scope of the invention. For example, each of the lines coupling the various devices in FIGS. 1-2 may comprise several lines, either in parallel or series, or mixed in form. Also, while FIG. 1 illustrates a single processor interface 250, connected to the DSP 240 by a single, bi-directional line 245, multiple processor interfaces or DSPs may be utilized in a master-slave configuration or in a parallel configuration. Additionally, the exemplary optical transceiver systems may be implemented in series or parallel having communication/processing buses between the systems. That is, for example, the controller 390 of the system in FIG. 3, may bridge additional exemplary optical transceiver systems (not shown).

Further, while FIG. 1 illustrates the invention as containing separate optical transceivers 210₁-210_{N} and the power supply unit 270, one of ordinary skill could arrange the optical transceivers 210₁-210_{N} (or a subset thereof) and/or the power supply unit 270, to be situated internally or externally from the system, as desired. Similarly, one of ordinary skill could incorporate or arrange the various components of the invention to increase or decrease the number of discrete components. As an illustrative example, the power supply unit 270 may be integrated into the processor interface 250, as desired, etc.

Therefore, while this invention has been described in conjunction with the specific embodiments discussed above, it is evident that many alternatives, modifications and variations will be apparent to those of skill in the art.

We claim:

1. A multi-port transceiver system interfacable with an optical transceiver,
comprising:
a signal processor coupled to an optical transceiver;
a processor interface coupled to the signal processor;
an external interface coupled to the processor interface; and
a client-side optical transceiver interface coupled to the signal processor,
wherein the processor interface enables communication between the signal processor and an external device coupled to the external interface, and the client-side optical transceiver interface enables transceiving of signals between the signal processor and a client-side optical transceiver coupled to the client-side optical transceiver interface.

2. The multi-port transceiver system according to claim 1, where the external device operates as a controller of the multi-port transceiver system.

3. The multi-port transceiver system according to claim 1, where the external device is another multi-port transceiver system.

4. The multi-port transceiver system according to claim 1, further comprising:
a plurality of client-side optical transceiver interfaces.

5. The multi-port transceiver system according to claim 1, further comprising:
a second signal processor in the multi-port transceiver system and coupled to the processor interface.

6. The multi-port transceiver system according to claim 1, further comprising:
a power supply unit coupled to at least the external interface.

7. The multi-port transceiver system according to claim 6, where the power supply unit is coupled to at least the processor interface.

8. The multi-port transceiver system according to claim 6, where the power supply unit is coupled to at least the signal processor.

9. The multi-port transceiver system according to claim 6, where the power supply unit is coupled to at least the client-side optical transceiver interface.

10. The multi-port transceiver system according to claim 6, where the power supply unit is a controllable power supply unit.

11. The multi-port transceiver system according to claim 6, where the power supply unit provides filtering capabilities.

12. A multi-port transceiver system interfacable with optical transceivers, comprising:
signal processing means for processing optical transceiving signals;
processor interfacing means for interfacing with the signal processing means;
external interfacing means for interfacing the processor interfacing means with an external device; and
client-side optical transceiver interfacing means for interfacing the signal processing means with an client-side optical transceiver.

13. The multi-port transceiver system according to claim 12, where the external device is a controlling means.

14. The multi-port transceiver system according to claim 12, where the external device is another multi-port transceiver system.

15. The multi-port transceiver system according to claim 12, further comprising:
a plurality of client-side optical transceiver interface means.

16. The multi-port transceiver system according to claim 12, further comprising:
a second signal processing means in the multi-port transceiver system and coupled to the processor interfacing means.

17. The multi-port transceiver system according to claim 12, further comprising:
a power supplying means coupled to the external interfacing means.

18. The multi-port transceiver system according to claim 17, where the power supplying means is coupled to the processor interfacing means.

19. The multi-port transceiver system according to claim 17, where the power supplying means is coupled to the signal processing means.

20. The multi-port transceiver system according to claim 17, where the power supply means is coupled to the client-side optical transceiver interface means.

21. The multi-port transceiver system according to claim 17, where the power supplying means is a controllable power supplying means.

22. The multi-port transceiver system according to claim 17, where the power supplying means provides filtering capabilities.

23. A method of transceiving optical signals in a multi-port transceiver system having an internal processor and an internal processor interface coupled to an external interface, the method comprising the steps of:
processing by the internal signal processor, signals received by or for transmission by optical transceivers;
providing additional processing to the internal signal processor by coupling an external processor to the external interface; and
processing by the internal signal processor, a signal communicated by an client-side optical transceiver interface.

24. The method of transceiving optical signals in a multi-port transceiver system according to claim 23, further comprising the step of:
controlling the multi-port transceiver system by the external processor to perform at least one network function.

25. The method of transceiving optical signals in a multi-port transceiver system according to claim 23, wherein
performing at least one of the steps of processing in parallel.

26. The method of transceiving optical signals in a multi-port transceiver system according to claim 23, further comprising the step of:
supplying a power signal to the external interface in the multi-port transceiver system.

27. The method of transceiving optical signals in a multi-port transceiver system according to claim 26, further comprising the step of supplying a power signal to the processor interface in the multi-port transceiver system.

28. The method of transceiving optical signals in a multi-port transceiver system according to claim 26, further comprising the step of supplying a power signal to the internal processor.

29. The method of transceiving optical signals in a multi-port transceiver system according to claim 26, further comprising the step of supplying a power signal to client-side optical transceiver interface.

30. The method of transceiving optical signals in a multi-port transceiver system according to claim 26, wherein the supplied power is a controllable supplied power.
